(19) United States
(12) Patent Application Publication
(10) Pub. No.: US 2025/0055805 A1
(43) Pub. Date: Feb. 13, 2025

(54) NETWORK RELAY DEVICE, NETWORK TRANSMISSION DEVICE, RELAY METHOD, PACKET TRANSMISSION METHOD, RELAY PROGRAM, AND PACKET TRANSMISSION PROGRAM

(71) Applicants: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(72) Inventor: Yasuaki SAKAMOTO, Osaka-shi, Osaka (JP)

(73) Assignees: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(21) Appl. No.: 18/720,688

(22) PCT Filed: Aug. 31, 2022
(86) PCT No.: PCT/JP2022/032733

§ 371 Date: Jun. 17, 2024

(30) Foreign Application Priority Data
Dec. 20, 2021 (JP) 2021-205850

(51) Int. Cl. H04L 47/283; H04L 47/32

(52) U.S. Cl. CPC H04L 47/283; H04L 47/32

(57) ABSTRACT

A network relay device constitutes a network for relaying a packet, and includes: a reception unit configured to receive the packet addressed to a destination device; an acquisition unit configured to acquire arrival upper-limit information and arrival lower-limit information from the packet received by the reception unit, the arrival upper-limit information indicating an arrival time limit of the packet to the destination device, the arrival lower-limit information indicating a lower limit of a time range in which the packet should be made to arrive at the destination device; and a transmission unit configured to perform a transmission process of transmitting the packet received by the reception unit, or a packet based on the packet received by the reception unit. The transmission unit performs a priority control in the transmission process, based on the arrival upper-limit information, and puts transmission of the packet on standby based on the arrival lower-limit information.

This application claims priority on Japanese Patent Application No. 2021-205850 filed on Dec. 20, 2021, the entire content of which is incorporated herein by reference.

### TECHNICAL FIELD

The present disclosure relates to a network relay device, a network transmission device, a relay method, a packet transmission method, a relay program, and a packet transmission program.

### BACKGROUND ART

NON PATENT LITERATURE 1 (ITU-T, “New Service and Capabilities for Network 2030: Description, Technical Gap and Performance Target Analysis”, October 2019) states that, by around 2030, stable communication with reduced and constant delay time will become necessary in communication between an in-vehicle device installed in a vehicle and a control device, for safe remote control of the vehicle.

### CITATION LIST

### Non Patent Literature

NON PATENT LITERATURE 1: ITU-T, “New Service and Capabilities for Network 2030: Description, Technical Gap and Performance Target Analysis”, October 2019

### SUMMARY OF THE INVENTION

A network relay device according to the present disclosure is a network relay device constituting a network for relaying a packet, and including: a reception unit configured to receive the packet that is addressed to a destination device; an acquisition unit configured to acquire arrival upper-limit information from the packet received by the reception unit, the arrival upper-limit information indicating an arrival time limit of the packet to the destination device; and a transmission unit configured to perform a priority control in transmitting the packet received by the reception unit or a packet based on the packet received by the reception unit, the priority control being performed based on the arrival upper-limit information acquired by the acquisition unit.

A network transmission device according to the present disclosure includes: a generation unit configured to generate a packet to be transmitted to a destination device, the packet including arrival upper-limit information indicating an arrival time limit of the packet to the destination device; and a transmission unit configured to transmit the packet generated by the generation unit to the destination device via a network.

A relay method according to the present disclosure is a relay method in a network relay device constituting a network for relaying a packet, and includes: receiving the packet that is addressed to a destination device; acquiring arrival upper-limit information from the received packet, the arrival upper-limit information indicating an arrival time limit of the packet to the destination device; and performing a priority control in transmitting the received packet or a packet based on the received packet, the priority control being performed based on the acquired arrival upper-limit information.

A packet transmission method according to the present disclosure is a packet transmission method in a network transmission device, and includes: generating a packet to be transmitted to a destination device, the packet including arrival upper-limit information indicating an arrival time limit of the packet to the destination device; and transmitting the generated packet to the destination device via a network.

A relay program according to the present disclosure is a relay program used in a network relay device constituting a network for relaying a packet, and the relay program causes a computer to function as: a reception unit configured to receive the packet that is addressed to a destination device; an acquisition unit configured to acquire arrival upper-limit information from the packet received by the reception unit, the arrival upper-limit information indicating an arrival time limit of the packet to the destination device; and a transmission unit configured to perform a priority control in transmitting the packet received by the reception unit or a packet based on the packet received by the reception unit, the priority control being performed based on the arrival upper-limit information acquired by the acquisition unit.

A packet transmission program according to the present disclosure is a packet transmission program used in a network transmission device, and the packet transmission program causes a computer to function as: a generation unit configured to generate a packet to be transmitted to a destination device, the packet including arrival upper-limit information indicating an arrival time limit of the packet to the destination device; and a transmission unit configured to transmit the packet generated by the generation unit to the destination device via a network.

One mode of the present disclosure can be realized not only as a network relay device that includes such a characteristic processing unit, but also as a semiconductor integrated circuit that realizes a part or the entirety of the network relay device, or as a communication system including a network relay device. Also, one mode of the present disclosure can be realized not only as a network transmission device that includes such a characteristic processing unit, but also as a semiconductor integrated circuit that realizes a part or the entirety of the network transmission device, or as a communication system including a network transmission device.

### BRIEF DESCRIPTION OF DRAWINGS

FIG. 1 shows an example of a configuration of a communication system according to the embodiment of the present disclosure.

FIG. 2 shows an example of a configuration of a transmission device according to the embodiment of the present disclosure.

FIG. 3 shows an example of an IP packet generated by a generation unit in the transmission device according to the embodiment of the present disclosure.

FIG. 4 shows an example of a time setting table stored in a storage unit in the transmission device according to the embodiment of the present disclosure.

FIG. 5 shows an example of a configuration of a relay device according to the embodiment of the present disclosure.

FIG. 6 shows an example of a configuration of a relay device according to the embodiment of the present disclosure.

FIG. 7 is a flowchart showing an example of an operation procedure when the transmission device according to the embodiment of the present disclosure transmits an IP packet.

FIG. 8 is a flowchart showing an example of an operation procedure when the relay device according to the embodiment of the present disclosure performs an IP packet relaying process.

### DETAILED DESCRIPTION

A technology for reducing a communication delay in a communication system including a network for relaying a packet between devices, has been desired.

### Problems to be Solved by the Present Disclosure

However, NON PATENT LITERATURE 1 does not propose any specific method for realizing stable communication as described above.

The present disclosure is made to solve the above problem, and an object of the present disclosure is to provide a network relay device, a network transmission device, a relay method, a packet transmission method, a relay program, and a packet transmission program capable of realizing more stable communication.

### Effects of the Present Disclosure

According to the present disclosure, more stable communication can be realized.

### Description of Embodiment of the Present Disclosure

First, contents of the embodiment of the present disclosure will be listed and described.

(1) A network relay device according to an embodiment of the present disclosure constitutes a network for relaying a packet, and the network relay device includes: a reception unit configured to receive the packet that is addressed to a destination device; an acquisition unit configured to acquire arrival upper-limit information and arrival lower-limit information from the packet received by the reception unit, the arrival upper-limit information indicating an arrival time limit of the packet to the destination device, the arrival lower-limit information indicating a lower limit of a time range in which the packet should be made to arrive at the destination device; and a transmission unit configured to perform a transmission process of transmitting the packet received by the reception unit, or a packet based on the packet received by the reception unit. The transmission unit performs a priority control in the transmission process, based on the arrival upper-limit information acquired by the acquisition unit, and puts transmission of the packet on standby based on the arrival lower-limit information acquired by the acquisition unit.

As described above, in the network relay device, the priority control in transmitting the received packet or a packet based on the received packet is performed based on the arrival upper-limit information of the received packet. In this configuration, for example, the priority control for the packet can be performed so that the packet can be made to arrive at the destination device earlier than the arrival time limit. Thus, delay in the arrival time of the packet can be inhibited from occurring. In addition, based on the arrival lower-limit information of the received packet, transmission of the packet is put on standby. In this configuration, for example, the priority control can be performed so that the packet arrives at the destination device at a time within the time range in which the packet should be made to arrive at the destination device. Thus, the packet can be made to arrive at the destination device within the desired time range. As a result, more stable communication can be realized.

(2) In the above (1), the transmission unit may discard the packet without transmitting the same, based on a result of comparison between current time and the arrival time limit indicated by the arrival upper-limit information.

With the above configuration, the packet, which cannot arrive at the destination device earlier than the arrival time limit in view of the result of comparison between the current time and the arrival time limit, is discarded, whereby load on the network can be reduced.

(3) A network transmission device according to the embodiment of the present disclosure includes: a generation unit configured to generate a packet to be transmitted to a destination device, the packet including arrival upper-limit information indicating an arrival time limit of the packet to the destination device; and a transmission unit configured to transmit the packet generated by the generation unit to the destination device via a network.

As described above, in the network transmission device, the packet including the arrival upper-limit information and addressed to the destination device is generated and transmitted. Therefore, in the network, for example, the priority control for the packet can be performed so that the packet can be made to arrive at the destination device earlier than the arrival time limit, whereby delay in the arrival time of the packet can be inhibited from occurring. As a result, more stable communication can be realized.

(4) In the above (3), the generation unit may generate the packet including the arrival upper-limit information that is determined according to the type of a service provided by the packet.

With the above configuration, in the network, based on the arrival upper-limit information determined for each service, a plurality of packets regarding different services can be collectively subjected to the priority control so that the packets can be made to arrive at the destination device earlier than their arrival time limits. For example, a plurality of packets regarding a plurality of types of services can be transmitted to an in-vehicle device as an example of the destination device. In this case, a comprehensive priority control for the plurality of packets can be performed based on the pieces of arrival upper-limit information of the packets regarding the different types of services.

(5) According to the above (3) or (4), the generation unit may generate the packet further including arrival lower-limit information that indicates a lower limit of a time range in which the packet should be made to arrive at the destination device.

With the above configuration, in the network, for example, the priority control for the packet is performed so that the packet can be made to arrive at the destination device at a time within the time range in which the packet should be made to arrive at the destination device. Thus, the packet can be made to arrive at the destination device within the desired time range.

(6) In the above (5), the generation unit may generate the packet including the arrival lower-limit information that is determined according to the type of a service provided by the packet.

With the above configuration, in the network, based on the arrival lower-limit information determined for each service, the priority control for a plurality of packets regarding different services can be uniformly performed so that the packets can be made to arrive at the destination device at times within the time range in which the packets should be made to arrive at the destination device.

(7) A relay method according to the embodiment of the present disclosure is a relay method in a network relay device, the network relay device constitutes a network for relaying a packet, and the relay method includes: receiving the packet that is addressed to a destination device; acquiring arrival upper-limit information and arrival lower-limit information from the received packet, the arrival upper-limit information indicating an arrival time limit of the packet to the destination device, the arrival lower-limit information indicating a lower limit of a time range in which the packet should be made to arrive at the destination device; and performing a transmission process of transmitting the received packet, or a packet based on the received packet. In performing the transmission process, a priority control in the transmission process is performed based on the acquired arrival upper-limit information, and transmission of the packet is put on standby based on the acquired arrival lower-limit information.

As described above, in the network relay device, the priority control in transmitting the received packet or a packet based on the received packet is performed based on the arrival upper-limit information of the received packet. In this method, for example, the priority control for the packet can be performed so that the packet can be made to arrive at the destination device earlier than the arrival time limit. Thus, delay in the arrival time of the packet can be inhibited from occurring. In addition, based on the arrival lower-limit information of the received packet, transmission of the packet is put on standby. In this method, for example, the priority control can be performed so that the packet arrives at the destination device at a time within the time range in which the packet should be made to arrive at the destination device. Thus, the packet can be made to arrive at the destination device within the desired time range. As a result, more stable communication can be realized.

(8) A packet transmission method according to the embodiment of the present disclosure is a packet transmission method in a network transmission device, and includes: generating a packet to be transmitted to a destination device, the packet including arrival upper-limit information indicating an arrival time limit of the packet to the destination device; and transmitting the generated packet to the destination device via a network.

As described above, in the network transmission device, the packet including the arrival upper-limit information and addressed to the destination device is generated and transmitted. In this method, in the network, for example, the priority control for the packet can be performed so that the packet can be made to arrive at the destination device earlier than the arrival time limit, whereby delay in the arrival time of the packet can be inhibited from occurring. As a result, more stable communication can be realized.

(9) A relay program according to the embodiment of the present disclosure is a relay program used in a network relay device, the network relay device constitutes a network for relaying a packet, and the relay program is a program for causing a computer to function as: a reception unit configured to receive the packet that is addressed to a destination device; an acquisition unit configured to acquire arrival upper-limit information and arrival lower-limit information from the packet received by the reception unit, the arrival upper-limit information indicating an arrival time limit of the packet to the destination device, the arrival lower-limit information indicating a lower limit of a time range in which the packet should be made to arrive at the destination device; and a transmission unit configured to perform a transmission process of transmitting the packet received by the reception unit, or a packet based on the packet received by the reception unit. The transmission unit performs a priority control in the transmission process, based on the arrival upper-limit information acquired by the acquisition unit, and puts transmission of the packet on standby based on the arrival lower-limit information acquired by the acquisition unit.

As described above, in the network relay device, the priority control in transmitting the received packet or a packet based on the received packet is performed based on the arrival upper-limit information of the received packet. In this configuration, for example, the priority control for the packet can be performed so that the packet can be made to arrive at the destination device earlier than the arrival time limit. Thus, delay in the arrival time of the packet can be inhibited from occurring. In addition, based on the arrival lower-limit information of the received packet, transmission of the packet is put on standby. In this configuration, for example, the priority control can be performed so that the packet arrives at the destination device at a time within the time range in which the packet should be made to arrive at the destination device. Thus, the packet can be made to arrive at the destination device within the desired time range. As a result, more stable communication can be realized.

(10) A packet transmission program according to the embodiment of the present disclosure is a packet transmission program used in a network transmission device, and causes a computer to function as: a generation unit configured to generate a packet to be transmitted to a destination device, the packet including arrival upper-limit information indicating an arrival time limit of the packet to the destination device; and a transmission unit configured to transmit the packet generated by the generation unit to the destination device via a network.

As described above, in the network transmission device, the packet including the arrival upper-limit information and addressed to the destination device is generated and transmitted. Therefore, in the network, for example, the priority control for the packet can be performed so that the packet can be made to arrive at the destination device earlier than the arrival time limit, whereby delay in the arrival time of the packet can be inhibited from occurring. As a result, more stable communication can be realized.

Hereinafter, an embodiment of the present disclosure will be described with reference to the drawings. In the drawings, the same or corresponding parts are denoted by the same reference signs, and description thereof is not repeated. At least some parts of the embodiment described below can be combined together as desired.

### Configuration and Basic Operation

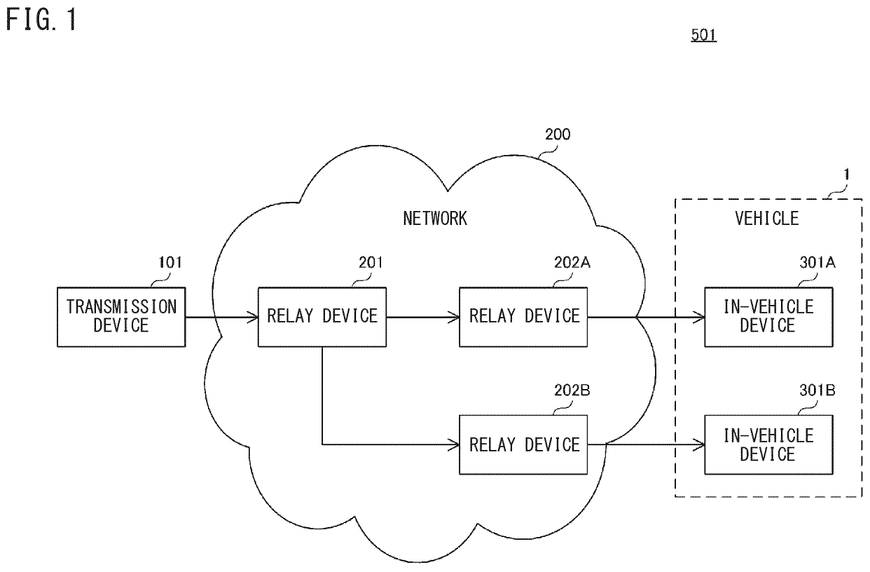

FIG. 1 shows an example of a configuration of a communication system according to an embodiment of the present disclosure. With reference to FIG. 1, a communication system 501 includes a transmission device 101, a relay device 201, relay devices 202A, 202B, and in-vehicle devices 301A, 301B. Hereinafter, each of the relay devices 202A, 202B is also referred to as a relay device 202, and each of the in-vehicle devices 301A, 301B is also referred to as an in-vehicle device 301. The transmission device 101 is an example of a network transmission device. The relay device 201 and the relay device 202 are examples of network relay devices. The in-vehicle device 301 is an example of a destination device. For example, the transmission device 101 and the relay devices 201, 202 are in time-synchronization with each other.

The in-vehicle device 301 is installed in a vehicle 1. As an example, the transmission device 101, the relay device 201, and the relay device 202 are located outside the vehicle 1. The communication system 501 may be configured to include three or more in-vehicle devices 301. In addition, the communication system 501 may be configured to include in-vehicle devices 301 installed in different vehicles 1.

The relay device 201 and the relay device 202 constitute a network 200 for relaying an IP (Internet Protocol) packet. The network 200 relays an IP packet between the transmission device 101 and the in-vehicle device 301 through wireless communication or wired communication. The network 200 is a WAN (Wide Area Network), for example.

The transmission device 101, as provision of a service, distributes distribution information to the in-vehicle device 301 at periodic or non-periodic distribution timings. For example, the transmission device 101 remotely controls the vehicle 1 by distributing, to the in-vehicle device 301, control information S1 as distribution information to be used for automated driving control of the vehicle 1. Furthermore, for example, the transmission device 101 distributes, to the in-vehicle device 301, switching information S2 as distribution information indicating a switching time tx being a timing at which a lighting state of a traffic signal changes.

More specifically, the transmission device 101 generates an IP packet including the distribution information and addressed to the in-vehicle device 301, and transmits the generated IP packet to the in-vehicle device 301 via the network 200.

The relay device 201 and the relay device 202 perform a relay process of relaying the IP packet transmitted from the transmission device 101, to the in-vehicle device 301.

For example, the relay device 201 transmits an IP packet PA received from the transmission device 101 and addressed to the in-vehicle device 301A, to the relay device 202A. The relay device 202A transmits the IP packet PA received from the relay device 201, to the in-vehicle device 301A.

Furthermore, for example, the relay device 201 transmits an IP packet PB received from the transmission device 101 and addressed to the in-vehicle device 301B, to the relay device 202B. The relay device 202B transmits the IP packet PB received from the relay device 201, to the in-vehicle device 301B.

The in-vehicle device 301 receives the IP packet from the transmission device 101 via the network 200, and acquires the distribution information from the received IP packet. For example, the in-vehicle device 301 drives the vehicle 1, based on the acquired distribution information.

More specifically, the in-vehicle device 301A receives the IP packet PA from the relay device 201A, acquires the distribution information from the received IP packet PA, and drives the vehicle 1, based on the acquired distribution information. The in-vehicle device 301B receives the IP packet PB from the relay device 201B, acquires the distribution information from the received IP packet PB, and drives the vehicle 1, based on the acquired distribution information.

In communication in the communication system 501 including the in-vehicle device 301, requirements regarding communication delay are stricter than in general consumer communication, from the viewpoint of safe driving, and an IP packet arrival time needs to be controlled in units of milliseconds or microseconds.

The communication system 501 may not necessarily include the relay device 202. In this case, the relay device 201 transmits, to the in-vehicle device 301A, the IP packet PA received from the transmission device 101 and addressed to the in-vehicle device 301A, and transmits, to the in-vehicle device 301B, the IP packet PB received from the transmission device 101 and addressed to the in-vehicle device 301B. The communication system 501 may be configured to include one relay device 202 or three or more relay devices 202.

At least one of the transmission device 101, the relay device 201, and the relay device 202 may be installed in the vehicle 1.

The destination of the IP packet from the transmission device 101 is not limited to the in-vehicle device 301. The transmission device 101 may be configured to generate an IP packet addressed to a device installed in, for example, a robot, and transmit the generated IP packet to the device via the network 200.

### Transmission Device 101

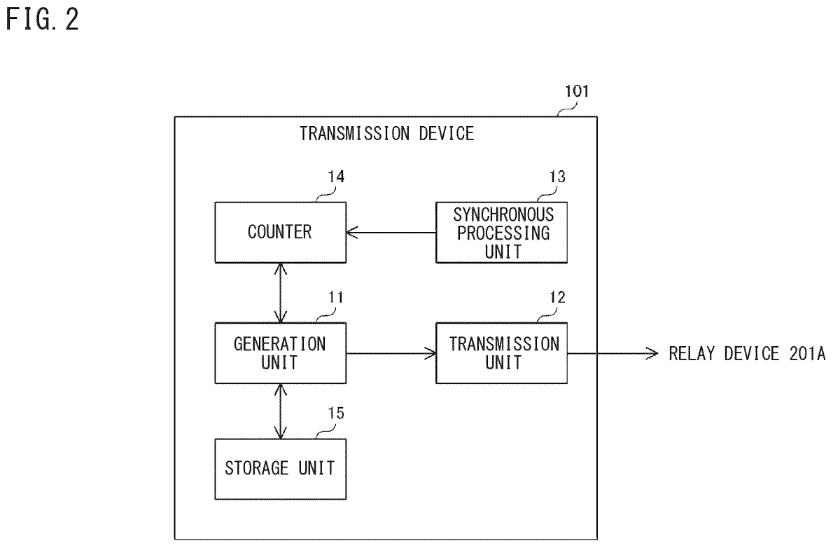

FIG. 2 shows an example of a configuration of a transmission device according to the embodiment of the present disclosure. With reference to FIG. 2, the transmission device 101 includes a generation unit 11, a transmission unit 12, a synchronous processing unit 13, a counter 14, and a storage unit 15. Some or all of the generation unit 11, the transmission unit 12, and the synchronous processing unit 13 are realized by, for example, processing circuitry including one or more processors. The storage unit 15 is, for example, a non-volatile memory included in the processing circuitry.

The counter 14 counts clock pulses generated by, for example, an oscillator circuit using a crystal oscillator, and holds time information indicating the counted value. This time information indicates, for example, the current time.

The synchronous processing unit 13 updates the count value of the counter 14 according to NTP (Network Time Protocol). More specifically, the synchronous processing unit 13, as an NTP client, periodically transmits an NTP request to an NTP server (not shown), for example. Upon receiving the NTP request from the synchronous processing unit 13, the NTP server transmits, as a response to the received NTP request, an NTP response including NTP information that is held by the NTP server and indicates the current time, to the synchronous processing unit 13. Upon receiving the NTP response from the NTP server, the synchronous processing unit 13 updates the time information of the counter 14, based on the NTP information included in the received NTP response and on a known communication delay time in communication between the synchronous processing unit 13 and the NTP server.

The generation unit 11 generates an IP packet that is an IP packet to be transmitted to the in-vehicle device 301 and including arrival upper-limit information. The arrival upper-limit information indicates an arrival time limit of the IP packet to the in-vehicle device 301. As an example, the generation unit 11 generates an IP packet including an arrival upper-limit time UL as the arrival upper-limit information.

For example, the generation unit 11 generates an IP packet further including arrival lower-limit information. The arrival lower-limit information indicates a lower limit of a time range in which the IP packet should be made to arrive at the in-vehicle device 301. As an example, the generation unit 11 generates an IP packet including an arrival lower-limit time LL as the arrival lower-limit information.

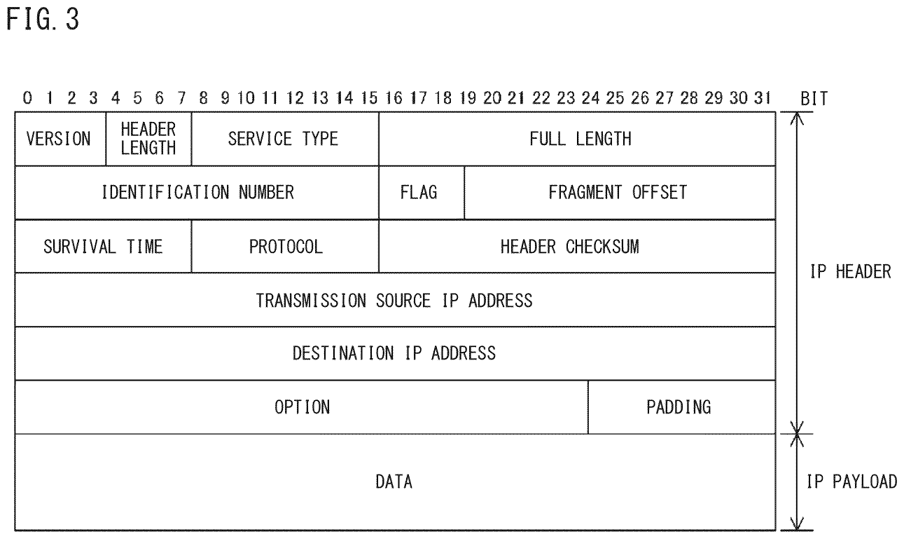

FIG. 3 shows an example of an IP packet generated by the generation unit in the transmission device according to the embodiment of the present disclosure. FIG. 3 shows, as an example, an IP packet conforming to IPv4 (Internet Protocol version 4). With reference to FIG. 3, the IP packet includes an IP header and an IP payload.

The generation unit 11 periodically or non-periodically generates distribution information, and determines an arrival upper-limit time UL and an arrival lower-limit time LL of the generated distribution information. Then, the generation unit 11 generates an IP packet, addressed to the in-vehicle device 301, in which the generated distribution information is stored in the IP payload, and the arrival upper-limit time UL and the arrival lower-limit time LL are stored in an option field in the IP header. The generation unit 11 may be configured to generate an IP packet in which the arrival upper-limit time UL and the arrival lower-limit time LL are stored in a field other than the option field.

For example, the generation unit 11 generates an IP packet including an arrival upper-limit time UL and an arrival lower-limit time LL that are determined according to the type of a service provided by the IP packet. More specifically, the generation unit 11 determines the arrival upper-limit time UL and the arrival lower-limit time LL according to the type of the distribution information stored in the IP payload in the IP packet.

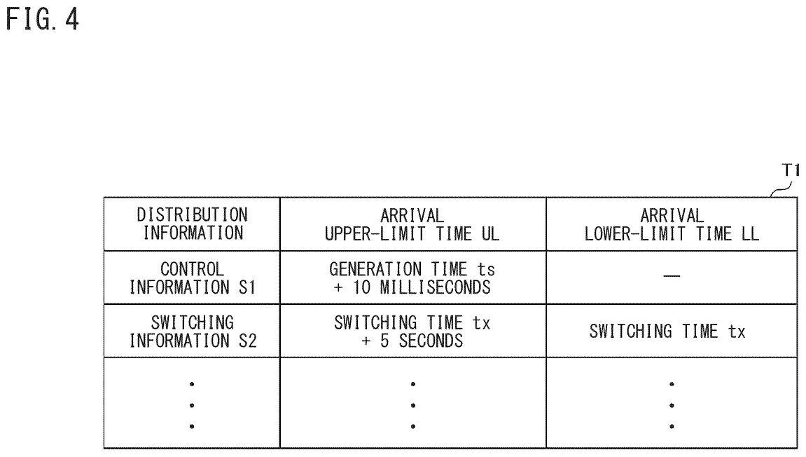

FIG. 4 shows an example of a time setting table stored in the storage unit in the transmission device according to the embodiment of the present disclosure. With reference to FIG. 4, the storage unit 15 has, stored therein, a time setting table T1 indicating the correspondence between the distribution information, and the arrival upper-limit time UL and the arrival lower-limit time LL.

The generation unit 11 generates distribution information, acquires an arrival upper-limit time UL corresponding to the generated distribution information with reference to the time setting table T1 stored in the storage unit 15, and stores the acquired arrival upper-limit time UL in the option field in the IP header of the IP packet.

If the arrival lower-limit time LL corresponding to the distribution information is present in the time setting table T1, the generation unit 11 further acquires this arrival lower-limit information, and stores the acquired arrival lower-limit time LL in the option field in the IP header of the IP packet. For example, when storing the arrival lower-limit time LL in the option field, the generation unit 11 further stores, in the option field, a flag indicating that the arrival lower-limit time LL is stored.

For example, the generation unit 11 generates control information S1 as the distribution information, and determines that the arrival upper-limit time UL should be set to “generation time ts+10 milliseconds” with reference to the time setting table T1. Then, the generation unit 11 acquires the current time indicated by the time information of the counter 14, as the generation time ts of the control information S1, and sets a time obtained by adding 10 milliseconds to the acquired generation time ts, as the arrival upper-limit time UL. The generation unit 11 stores the determined arrival upper-limit time UL in the option field in the IP header of the IP packet, and outputs the IP packet to the transmission unit 12.

For example, the generation unit 11 acquires a switching time tx from a signal control device (not shown) that controls the light color of a traffic signal, and generates switching information S2 indicating the acquired switching time tx. Then, with reference to the time setting table T1, the generation unit 11 determines that the arrival upper-limit time UL and the arrival lower-limit time LL should be set to “switching time tx+5 seconds” and “switching time tx”, respectively. Then, the generation unit 11 stores the switching time tx, and a time obtained by adding 5 seconds to the switching time tx in the option field in the IP header of the IP packet, and outputs the IP packet to the transmission unit 12.

The transmission unit 12 transmits the IP packet generated by the generation unit 11 to the in-vehicle device 301 via the network 200. More specifically, the transmission unit 12 transmits the IP packet received from the generation unit 11, to the relay device 201. For example, the arrival upper-limit time of the IP packet including the control information S1 is set to “generation time ts+10 milliseconds”, and the IP packet is caused to arrive at the in-vehicle device 301 by the arrival upper-limit time, whereby highly real-time control can be realized.

Moreover, for example, the arrival lower-limit time of the IP packet including the switching information S2 is set to the switching time tx, and the IP packet is transmitted in advance before the switching time tx to a plurality of in-vehicle devices 301 installed in the same vehicle 1 or different vehicles 1, whereby congestion of IP packets can be avoided, compared to the configuration in which the IP packet is simultaneously transmitted to the plurality of in-vehicle devices 301 when the switching time tx has been reached.

### Relay Device 201

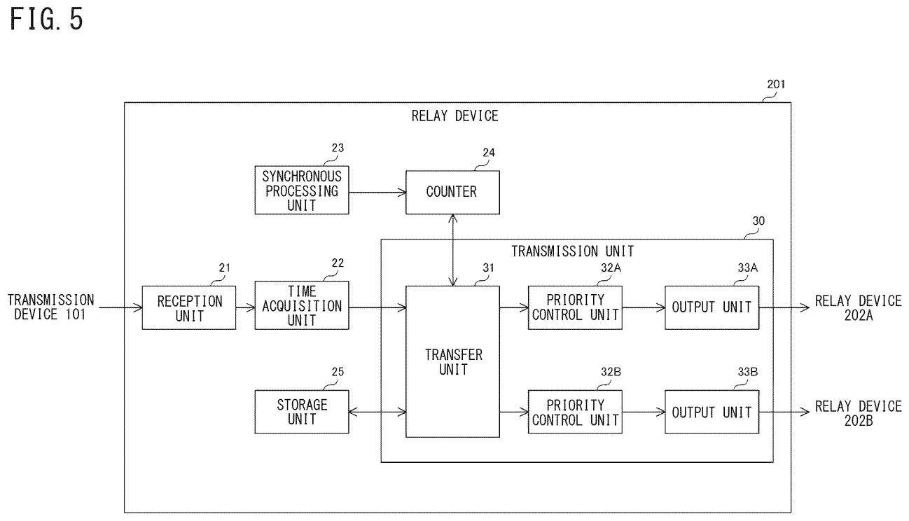

FIG. 5 shows an example of a configuration of a relay device according to the embodiment of the present disclosure. FIG. 5 shows the configuration of the relay device 201. With reference to FIG. 5, the relay device 201 includes a reception unit 21, a time acquisition unit 22, a synchronous processing unit 23, a counter 24, a storage unit 25, and a transmission unit 30. The time acquisition unit 22 is an example of an acquisition unit. Some or all of the reception unit 21, the time acquisition unit 22, the synchronous processing unit 23, and the transmission unit 30 are realized by, for example, processing circuitry including one or more processors. The storage unit 25 is, for example, a non-volatile memory included in the processing circuitry. For example, the storage unit 25 has, stored therein, a correspondence table T2 indicating the correspondence between a destination IP address of an IP packet and a relay device 202 as a relay destination of the IP packet.

The transmission unit 30 includes a transfer unit 31, priority control units 32A, 32B, and output units 33A, 33B. Hereinafter, each of the priority control units 32A, 32B is also referred to as a priority control unit 32, and each of the output units 33A, 33B is also referred to as an output unit 33. For example, the transmission unit 30 includes a priority control unit 32 and an output unit 33 corresponding to each relay device 202. More specifically, the transmission unit 30 includes a priority control unit 32A and an output unit 33A corresponding to the relay device 202A, and a priority control unit 32B and an output unit 33B corresponding to the relay device 202B.

The counter 24 counts clock pulses generated by, for example, an oscillator circuit using a crystal oscillator, and holds time information indicating the counted value. This time information indicates, for example, the current time.

The synchronous processing unit 23 updates the count value of the counter 24 according to the NTP, like the synchronous processing unit 13 in the transmission device 101. Thus, the counter 14 in the transmission device 101 can be synchronized with the counter 24 in the relay device 201.

The reception unit 21 receives an IP packet addressed to the in-vehicle device 301. More specifically, the reception unit 21 receives an IP packet addressed to the in-vehicle device 301 from the transmission device 101. The reception unit 21 outputs the received IP packet to the time acquisition unit 22.

The time acquisition unit 22 acquires arrival upper-limit information from the IP packet received by the reception unit 21. More specifically, the time acquisition unit 22 receives the IP packet from the reception unit 21, and acquires arrival upper-limit time UL from the option field in the IP header of the received IP packet. The time acquisition unit 22 outputs the IP packet and the acquired arrival upper-limit time UL to the transmission unit 30.

Based on the arrival upper-limit time UL acquired by the time acquisition unit 22, the transmission unit 30 performs a priority control in transmitting the IP packet received by the reception unit 21. For example, the transmission unit 30 receives the IP packet and the arrival upper-limit time UL from the time acquisition unit 22, and schedules the transmission order of the IP packet for each relay device 202 being a relay destination, based on the arrival upper-limit time UL. The transmission unit 30 transmits the IP packet to the relay device 202 according to the result of the scheduling.

More specifically, the transfer unit 31 in the transmission unit 30 receives the IP packet and the arrival upper-limit time UL from the time acquisition unit 22, and acquires a destination IP address from the received IP packet. Based on the correspondence table T2 in the storage unit 25 and the acquired destination IP address, the transfer unit 31 determines a relay device 202 being a relay destination of the IP packet. Then, the transfer unit 31 outputs the IP packet and the arrival upper-limit time UL received from the time acquisition unit 22, to the priority control unit 32 corresponding to the relay device 202 being the relay destination of the IP packet.

Specifically, when the relay destination of the IP packet is the relay device 202A, the transfer unit 31 outputs the IP packet and the arrival upper-limit time UL to the priority control unit 32A. Meanwhile, when the relay destination of the IP packet is the relay device 202B, the transfer unit 31 outputs the IP packet and the arrival upper-limit time UL to the priority control unit 32B.

Upon receiving the IP packet being a transmission target from the transfer unit 31, the priority control unit 32 holds the received IP packet. The priority control unit 32 outputs an IP packet having the earliest arrival upper-limit time UL among one or more IP packets being held, to the output unit 33 at an output timing according to a predetermined cycle.

Upon receiving the IP packet from the priority control unit 32, the output unit 33 transmits the received IP packet to the corresponding relay device 202.

The transmission unit 30 may be configured to perform a priority control in transmitting an IP packet based on the IP packet received by the reception unit 21, according to the arrival upper-limit time UL acquired by the time acquisition unit 22. More specifically, the relay device 201 further includes a processing unit (not shown) that performs processing such as conversion and deletion of data of the IP packet received by the reception unit 21. The transmission unit 30 performs the priority control in transmitting the IP packet processed by the processing unit to the relay device 202.

### Discard of IP Packet

For example, the transmission unit 30 discards an IP packet without transmitting the same, based on a result of comparison between the current time and the arrival upper-limit time UL.

More specifically, the transfer unit 31 receives the IP packet and the arrival upper-limit time UL from the time acquisition unit 22, and compares the received arrival upper-limit time UL with the current time indicated by the time information of the counter 24. The transfer unit 31 discards the IP packet according to a time length TL1 from the current time to the arrival upper-limit time UL.

Specifically, the transfer unit 31 outputs the IP packet and the arrival upper-limit time UL to the priority control unit 32 when the time length TL1 from the current time to the arrival upper-limit time UL of the IP packet is equal to or longer than a predetermined threshold value Th1. Meanwhile, the transfer unit 31 discards the IP packet when the time length TL1 from the current time to the arrival upper-limit time UL of the IP packet is shorter than the threshold value Th1 or when the current time has exceeded the arrival upper-limit time UL.

For example, the storage unit 25 has, stored therein, different threshold values Th1 corresponding to the destination IP addresses. The transfer unit 31 acquires, from the storage unit 25, the threshold value Th1 corresponding to the destination IP address of the IP packet received from the time acquisition unit 22, and compares the acquired threshold value Th1 with the time length TL1. According to a result of the comparison, the transfer unit 31 outputs the IP packet to the priority control unit 32 or discards the IP packet.

### Putting IP Packet Transmission on Standby Based on Arrival Lower-Limit Time LL

For example, the time acquisition unit 22 further acquires arrival lower-limit information from the IP packet. More specifically, if the arrival lower-limit time LL is stored in the option field in the IP header of the IP packet received from the reception unit 21, the time acquisition unit 22 further acquires the arrival lower-limit time LL. The time acquisition unit 22 outputs the IP packet, and the acquired arrival upper-limit time UL and arrival lower-limit time LL to the transmission unit 30.

For example, the transmission unit 30 puts transmission of the IP packet on standby based on the arrival lower-limit time LL acquired by the time acquisition unit 22.

More specifically, the transfer unit 31 in the transmission unit 30 receives the IP packet, the arrival upper-limit time UL, and the arrival lower-limit time LL from the time acquisition unit 22, and compares the received arrival lower-limit time LL with the current time indicated by the time information of the counter 24. The transfer unit 31 waits before outputting the IP packet to the priority control unit 32, based on a result of the comparison between the current time and the arrival lower-limit time LL.

Specifically, when the current time has already been reached the arrival lower-limit time LL or when the time length TL2 from the current time to the arrival lower-limit time LL of the IP packet is shorter than a predetermined threshold value Th2, the transfer unit 31 outputs the IP packet and the arrival upper-limit time UL to the priority control unit 32 corresponding to the relay device 202 being the relay destination of the IP packet.

Meanwhile, when the current time has not yet been reached the arrival lower-limit time LL and the time length TL2 from the current time to the arrival lower-limit time LL of the IP packet is equal to or longer than the threshold value Th2, the transfer unit 31 stores the IP packet and the arrival upper-limit time UL received from the time acquisition unit 22 into the storage unit 25, and waits for the time length TL2 to become shorter than the threshold value Th2. When the time length TL2 has become shorter than the threshold value Th2, the transfer unit 31 acquires the corresponding IP packet and arrival upper-limit time UL from the storage unit 25, and outputs the acquired IP packet and arrival upper-limit time UL to the priority control unit 32 corresponding to the relay device 202 being the relay destination of the IP packet.

For example, the storage unit 25 has, stored therein, different threshold values Th2 corresponding to the destination IP addresses. The transfer unit 31 acquires, from the storage unit 25, the threshold value Th2 corresponding to the destination IP address of the IP packet received from the time acquisition unit 22, and compares the acquired threshold value Th2 with the time length TL2. According to a result of the comparison, the transfer unit 31 outputs the IP packet to the priority control unit 32 or suspends outputting of the IP packet to the priority control unit 32.

### Relay Device 202

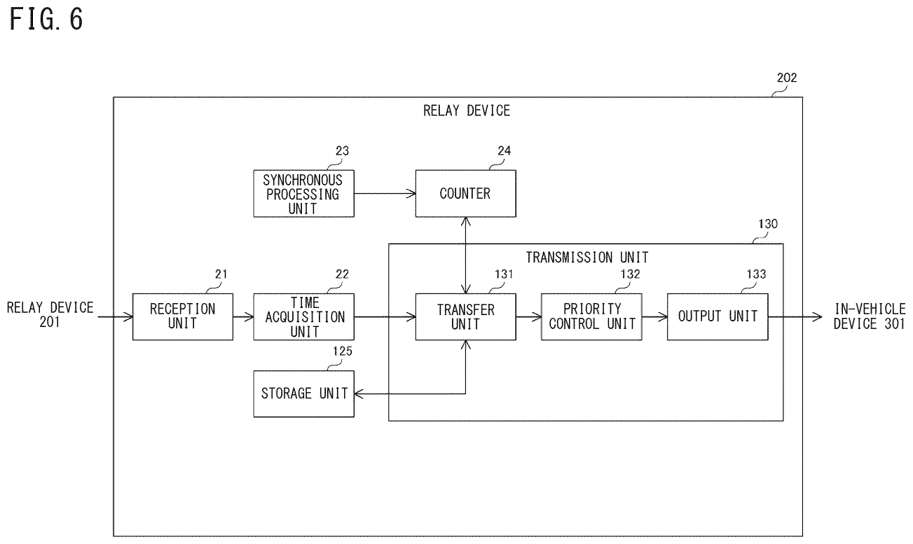

FIG. 6 shows an example of a configuration of a relay device according to the embodiment of the present disclosure. FIG. 6 shows the configuration of the relay device 202. With reference to FIG. 6, the relay device 202 is different from the relay device 201 in that the relay device 202 includes a transmission unit 130 instead of the transmission unit 30, and a storage unit 125 instead of the storage unit 25. Some or all of the reception unit 21, the time acquisition unit 22, the synchronous processing unit 23, and the transmission unit 130 are realized by, for example, processing circuitry including one or more processors. The storage unit 125 is, for example, a non-volatile memory included in the processing circuitry. For example, the storage unit 125 has, stored therein, address information indicating a destination IP address of an IP packet to be relayed.

The transmission unit 130 includes a transfer unit 131, a priority control unit 132, and an output unit 133.

The reception unit 21 receives an IP packet addressed to the in-vehicle device 301 from the relay device 201, and outputs the received IP packet to the time acquisition unit 22.

Furthermore, as described above, the time acquisition unit 22 receives an IP packet from the reception unit 21, and acquires the arrival upper-limit time UL from the option field in the IP header of the received IP packet. Then, the time acquisition unit 22 outputs the IP packet and the acquired arrival upper-limit time UL to the transmission unit 30.

Based on the arrival upper-limit time UL acquired by the time acquisition unit 22, the transmission unit 130 performs a priority control in transmitting the IP packet received by the reception unit 21. For example, the transmission unit 130 receives the IP packet and the arrival upper-limit time UL from the time acquisition unit 22, and schedules the transmission order of the IP packet to the in-vehicle device 301, based on the arrival upper-limit time UL. The transmission unit 130 transmits the IP packet to the in-vehicle device 301 according to the result of the scheduling.

More specifically, the transfer unit 131 in the transmission unit 130 receives the IP packet and the arrival upper-limit time UL from the time acquisition unit 22, and acquires a destination IP address from the received IP packet. When the acquired destination IP address matches the destination IP address indicated by the address information stored in the storage unit 125, the transfer unit 131 outputs the IP packet and the arrival upper-limit time UL received from the time acquisition unit 22 to the priority control unit 132. Meanwhile, when the acquired destination IP address does not match the destination IP address indicated by the address information stored in the storage unit 125, the transfer unit 131, for example, discards the IP packet and the arrival upper-limit time UL received from the time acquisition unit 22.

The priority control unit 132 receives the IP packet from the transfer unit 131, and holds the received IP packet. The priority control unit 132 outputs an IP packet having the earliest arrival upper-limit time UL among one or more IP packets being held, to the output unit 133 at an output timing according to a predetermined cycle.

The output unit 133 receives the IP packet from the priority control unit 132, and transmits the received IP packet to the in-vehicle device 301.

The transmission unit 130 may be configured to perform a priority control in transmitting an IP packet based on the IP packet received by the reception unit 21, according to the arrival upper-limit time UL acquired by the time acquisition unit 22. More specifically, the relay device 202 further includes a processing unit (not shown) that performs processing such as conversion and deletion of data of the IP packet received by the reception unit 21. The transmission unit 130 performs a priority control in transmitting the IP packet processed by the processing unit to the in-vehicle device 301.

### Discard of IP Packet

For example, the transmission unit 130 discards an IP packet without transmitting the same, based on a result of comparison between the current time and the arrival upper-limit time UL. More specifically, the transfer unit 131 in the transmission unit 130 receives the IP packet and the arrival upper-limit time UL from the time acquisition unit 22, and compares the received arrival upper-limit time UL with the current time indicated by the time information of the counter 24. The transfer unit 131 discards the IP packet according to the time length TL1 from the current time to the arrival upper-limit time UL.

For example, the storage unit 125 has, stored therein, different threshold values Th1 corresponding to the destination IP addresses. The transfer unit 131 acquires, from the storage unit 125, the threshold value Th1 corresponding to the destination IP address of the IP packet received from the time acquisition unit 22, and compares the acquired threshold value Th1 with the time length TL1. According to a result of the comparison, transfer unit 131 outputs the IP packet to the priority control unit 132, or discards the IP packet.

### Putting IP Packet Transmission on Standby Based on Arrival Lower-Limit Time LL

For example, the time acquisition unit 22 further acquires the arrival lower-limit time LL from the IP packet. More specifically, if the arrival lower-limit time LL is stored in the option field in the IP header of the IP packet received from the reception unit 21, the time acquisition unit 22 further acquires the arrival lower-limit time LL. The time acquisition unit 22 outputs the IP packet and the acquired arrival upper-limit time UL and arrival lower-limit time LL to the transmission unit 130.

For example, the transmission unit 130 puts transmission of the IP packet on standby based on the arrival lower-limit time LL acquired by the time acquisition unit 22. More specifically, the transfer unit 131 in the transmission unit 130 receives the IP packet, the arrival upper-limit time UL, and the arrival lower-limit time LL from the time acquisition unit 22, and compares the received arrival lower-limit time LL with the current time indicated by the time information of the counter 24. The transfer unit 131 waits before outputting the IP packet to the priority control unit 32, based on a result of the comparison between the current time and the arrival lower-limit time LL.

Specifically, when the current time has already been reached the arrival lower-limit time LL or when the time length TL2 from the current time to the arrival lower-limit time LL of the IP packet is shorter than the predetermined threshold value Th2, the transfer unit 131 outputs the IP packet and the arrival upper-limit time UL to the priority control unit 132. Meanwhile, when the current time has not yet been reached the arrival lower-limit time LL and the time length TL2 from the current time to the arrival lower-limit time LL of the IP packet is equal to or longer than the threshold value Th2, the transfer unit 131 stores the IP packet and the arrival upper-limit time UL received from the time acquisition unit 22 into the storage unit 125, and waits for the time length TL2 to become shorter than the threshold value Th2. When the time length TL2 has become shorter than the threshold value Th2, the transfer unit 131 acquires the corresponding IP packet and arrival upper-limit time UL from the storage unit 125, and outputs the acquired IP packet and arrival upper-limit time UL to the priority control unit 132.

For example, the storage unit 125 has, stored therein, different threshold values Th2 corresponding to the destination IP addresses. The transfer unit 131 acquires, from the storage unit 125, the threshold value Th2 corresponding to the destination IP address of the IP packet received from the time acquisition unit 22, and compares the acquired threshold value Th2 with the time length TL2. According to a result of the comparison, the transfer unit 131 outputs the IP packet to the priority control unit 132, or suspends outputting of the IP packet to the priority control unit 132.

### Operation Flow

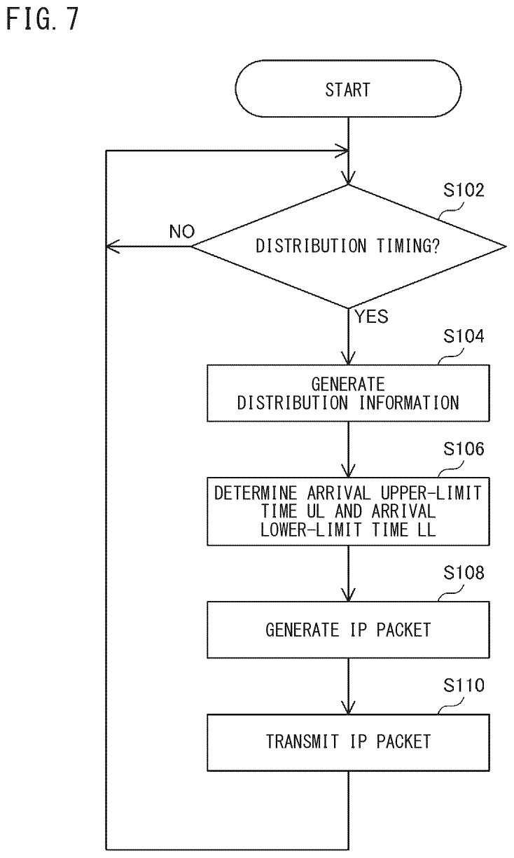

FIG. 7 is a flowchart showing an example of an operation procedure when the transmission device according to the embodiment of the present disclosure transmits an IP packet.

With reference to FIG. 7, first, the transmission device 101 waits for a distribution timing of distribution information to the in-vehicle device 301 (NO in step S102), and when the distribution timing has come (YES in step S102), generates distribution information (step S104).

Next, the transmission device 101 determines an arrival upper-limit time UL and an arrival lower-limit time LL of the generated distribution information (step S106).

Next, the transmission device 101 generates an IP packet, addressed to the in-vehicle device 301, in which the distribution information is stored in an IP payload, and the arrival upper-limit time UL and the arrival lower-limit time LL are stored in an option field in an IP header (step S108).

Next, the transmission device 101 transmits the generated IP packet to the in-vehicle device 301 via the network 200 (step S110).

Next, the transmission device 101 waits for a new distribution timing (NO in step S102).

In step S106, the transmission device 101 may not necessarily determine the arrival lower-limit time LL while determining the arrival upper-limit time UL. In this case, in step S108, the transmission device 101 generates the IP packet that includes the arrival upper-limit time UL and does not include the arrival lower-limit time LL.

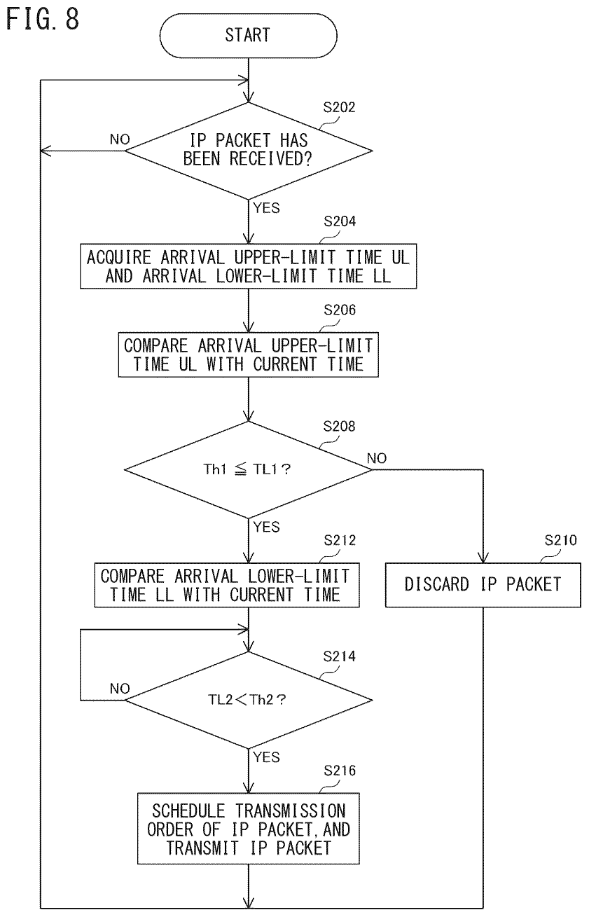

FIG. 8 is a flowchart showing an example of an operation procedure when the relay device according to the embodiment of the present disclosure performs an IP packet relaying process. FIG. 8 is a flowchart showing an operation procedure when the relay device 201 performs an IP packet relaying process.

With reference to FIG. 8, first, the relay device 201 waits for an IP packet addressed to the in-vehicle device 301 (NO in step S202), and when receiving an IP packet addressed to the in-vehicle device 301 (YES in step S202), acquires an arrival upper-limit time UL and an arrival lower-limit time LL from the received IP packet (step S204).

Next, the relay device 201 compares the arrival upper-limit time UL with the current time indicated by the time information of the counter 24 (step S206).

Next, when the time length TL1 from the current time to the arrival upper-limit time UL of the IP packet is shorter than the threshold value Th1 corresponding to the destination IP address of the IP packet or when the current time has exceeded the arrival upper-limit time UL (NO in step S208), the relay device 201 discards the IP packet (step S210).

Next, the relay device 201 waits for a new IP packet addressed to the in-vehicle device 301 (NO in step S202).

Meanwhile, when the time length TL1 from the current time to the arrival upper-limit time UL of the IP packet is equal to or longer than the threshold value Th1 (YES in step S208), the relay device 201 compares the arrival upper-limit time UL with the current time indicated by the time information of the counter 24 (step S212).

Next, when the current time has already been reached the arrival lower-limit time LL or when the time length TL2 from the current time to the arrival lower-limit time LL of the IP packet is shorter than the threshold value Th2 (YES in step S214), the relay device 201 schedules the transmission order of the IP packet for each relay device 202 being the relay destination, based on the arrival upper-limit time UL, and transmits the IP packet to the relay device 202 according to the result of the scheduling (step S216).

Meanwhile, when the current time has not yet been reached the arrival lower-limit time LL and the time length TL2 is equal to or longer than the threshold value Th2 (NO in step S214), the relay device 201 waits for the time length TL2 to become shorter than the threshold value Th2. When the time length TL2 has become shorter than the threshold value Th2 (YES in step S214), the relay device 201 performs a priority control in transmitting the IP packet, based on the arrival upper-limit time UL. More specifically, based on the arrival upper-limit time UL, the relay device 201 schedules the transmission order of the IP packet for each relay device 202 being the relay destination, and transmits the IP packet to the relay device 202 according to the result of the scheduling (step S216).

Next, the relay device 201 waits for a new IP packet addressed to the in-vehicle device 301 (NO in step S202).

If the received IP packet has no arrival lower-limit time LL stored therein, the relay device 201 does not perform the processes in steps S212, S214.

In the transmission device 101 according to the embodiment of the present disclosure, the generation unit 11 generates the IP packet including the arrival upper-limit time UL and the arrival lower-limit time LL that are determined according to the type of the service provided by the IP packet. However, the present disclosure is not limited thereto. The generation unit 11 may determine the arrival upper-limit time UL and the arrival lower-limit time LL based on, for example, the generation time of the distribution information, regardless of the service provided by the IP packet, and may generate the IP packet including the determined arrival upper-limit time UL and arrival lower-limit time LL.

In the relay device 201 according to the embodiment of the present disclosure, the transmission unit 30 discards the IP packet without transmitting the same, based on the result of comparison between the current time and the arrival upper-limit time UL. However, the present disclosure is not limited thereto. For example, the transmission unit 30 may transmit the IP packet regardless of the result of comparison between the current time and the arrival upper-limit time UL. Specifically, the transmission unit 30 may transmit the IP packet not only when the time length TL1 from the current time to the arrival upper-limit time UL of the IP packet is equal to or longer than the threshold value Th1, but also when, for example, the current time has exceeded the arrival upper-limit time UL. Likewise, the transmission unit 130 in the relay device 202 may transmit the IP packet not only when the time length TL1 from the current time to the arrival upper-limit time UL of the IP packet is equal to or longer than the threshold value Th1, but also when, for example, the current time has exceeded the arrival upper-limit time UL.

In the communication system 501 according to the embodiment of the present disclosure, the relay device 201 includes the time acquisition unit 22 and the priority control unit 32, and the relay device 202 includes the time acquisition unit 22 and the priority control unit 132. However, the present disclosure is not limited thereto. The relay device 202 may not necessarily include the time acquisition unit 22 and the priority control unit 132 while the relay device 201 includes the time acquisition unit 22 and the priority control unit 32. Alternatively, the relay device 201 may not necessarily include the time acquisition unit 22 and the priority control unit 32 while the relay device 202 includes the time acquisition unit 22 and the priority control unit 132. That is, one of the relay device 201 and the relay device 202 may not necessarily perform the priority control in transmitting the IP packet, based on the arrival upper-limit time.

Meanwhile, a technology enabling more stable communication has been desired. More specifically, with an increase in communication speed in recent years, highly real-time, stable communication with reduced communication delay has been desired. For example, technologies such as DiffServ (Differentiated Services) type QoS (Quality of Service), IntServ type QoS, and centralized QoS are known as IP packet priority control in a wide area IP network. With these technologies, however, a delay may occur in the arrival time of an IP packet to a destination device, which makes it difficult to realize stable communication.

Meanwhile, in the relay device 201 according to the embodiment of the present disclosure, the reception unit 21 receives an IP packet addressed to the in-vehicle device 301. The time acquisition unit 22 acquires, from the IP packet received by the reception unit 21, the arrival upper-limit time UL indicating the arrival time limit of the IP packet to the in-vehicle device 301. Based on the arrival upper-limit time UL acquired by the time acquisition unit 22, the transmission unit 30 performs the priority control in transmitting the IP packet received by the reception unit 21 or an IP packet based on the IP packet received by the reception unit 21.

As described above, in the relay device 201 and the relay device 202, the priority control in transmitting the received IP packet or an IP packet based on the received IP packet is performed based on the arrival upper-limit time UL of the received IP packet. In this configuration, for example, the priority control for the IP packet can be performed so that the IP packet can be made to arrive at the in-vehicle device 301 earlier than the arrival upper-limit time UL. Thus, delay in the arrival time of the IP packet can be inhibited from occurring. Therefore, in the relay device 201 and the relay device 202 according to the embodiment of the present disclosure, more stable communication can be realized.

The above embodiment is merely illustrative in all aspects and should not be recognized as being restrictive. The scope of the present disclosure is defined by the scope of the claims rather than by the description above, and is intended to include meaning equivalent to the scope of the claims and all modifications within the scope.

The processes (functions) of the above-described embodiment may be realized by processing circuitry including one or more processors. In addition to the one or more processors, the processing circuitry may include an integrated circuit or the like in which one or more memories, various analog circuits, and various digital circuits are combined. The one or more memories have, stored therein, programs (instructions) that cause the one or more processors to execute the processes. The one or more processors may execute the processes according to the program read out from the one or more memories, or may execute the processes according to a logic circuit designed in advance to execute the processes. The above processors may include a CPU (Central Processing Unit), a GPU (Graphics Processing Unit), a DSP (Digital Signal Processor), an FPGA (Field Programmable Gate Array), an ASIC (Application Specific Integrated Circuit), etc., which are compatible with computer control. The physically separated processors may execute the processes in cooperation with each other. For example, the processors installed in physically separated computers may execute the processes in cooperation with each other through a network such as a LAN (Local Area Network), a WAN (Wide Area Network), or the Internet. The program may be installed in the memory from an external server device or the like through the network. Alternatively, the program may be distributed in a state of being stored in a recording medium such as a CD-ROM (Compact Disc Read Only Memory), a DVD-ROM (Digital Versatile Disk Read Only Memory), or a semiconductor memory, and may be installed in the memory from the recording medium.

The above description includes the features in the additional notes below.

### Additional Note 1

A network relay device constituting a network for relaying a packet, comprising:
a reception unit configured to receive the packet that is addressed to a destination device;
an acquisition unit configured to acquire arrival upper-limit information from the packet received by the reception unit, the arrival upper-limit information indicating an arrival time limit of the packet to the destination device; and
a transmission unit configured to perform a priority control in transmitting the packet received by the reception unit or a packet based on the packet received by the reception unit, the priority control being performed based on the arrival upper-limit information acquired by the acquisition unit, wherein
the reception unit receives the packet from a network transmission device, and
the network transmission device and the network relay device are in time-synchronization with each other.

### Additional Note 2

A network relay device, comprising:
a generation unit configured to generate a packet to be transmitted to a destination device, the packet including arrival upper-limit information indicating an arrival time limit of the packet to the destination device; and
a transmission unit configured to transmit the packet generated by the generation unit to the destination device via a network, wherein
the network transmission device and a network relay device constituting the network are in time-synchronization with each other.

### Additional Note 3

A network relay device,
the network relay device constituting a network for relaying a packet,
the network relay device comprising processing circuitry,
the processing circuitry being configured to:
receive the packet that is addressed to a destination device;
acquire, from the received packet, arrival upper-limit information indicating an arrival time limit of the packet to the destination device;
perform a transmission process of transmitting the received packet, or a packet based on the received packet; and
perform a priority control in the transmission process, based on the acquired arrival upper-limit information.

### Additional Note 4

A network transmission device, comprising processing circuitry,
the processing circuitry being configured to:
generate a packet to be transmitted to a destination device, the packet including arrival upper-limit information indicating an arrival time limit of the packet to the destination device; and
transmit the generated packet to the destination device via a network.

### REFERENCE SIGNS LIST

1 vehicle
11 generation unit
12 transmission unit
13 synchronous processing unit
14 counter
15 storage unit
21 reception unit
22 time acquisition unit
23 synchronous processing unit
24 counter
25 storage unit
30 transmission unit
31 transfer unit
32A, 32B, 32 priority control unit
33A, 33B, 33 output unit
101 transmission device
125 storage unit
130 transmission unit
131 transfer unit
132 priority control unit
133 output unit
200 network
201 relay device
202A, 202B, 202 relay device
301A, 301B, 301 in-vehicle device
501 communication system
T1 time setting table

1. A network relay device,
the network relay device constituting a network for relaying a packet,
the network relay device comprising:
a reception unit configured to receive the packet that is addressed to a destination device;
an acquisition unit configured to acquire arrival upper-limit information and arrival lower-limit information from the packet received by the reception unit, the arrival upper-limit information indicating an arrival time limit of the packet to the destination device, the arrival lower-limit information indicating a lower limit of a time range in which the packet should be made to arrive at the destination device; and
a transmission unit configured to perform a transmission process of transmitting the packet received by the reception unit, or a packet based on the packet received by the reception unit, wherein
the transmission unit performs a priority control in the transmission process, based on the arrival upper-limit information acquired by the acquisition unit, and puts transmission of the packet on standby based on the arrival lower-limit information acquired by the acquisition unit.

2. The network relay device according to claim 1, wherein
the transmission unit discards the packet without transmitting the same, based on a result of comparison between current time and the arrival time limit indicated by the arrival upper-limit information.

3. A network transmission device, comprising:
a generation unit configured to generate a packet to be transmitted to a destination device, the packet including arrival upper-limit information indicating an arrival time limit of the packet to the destination device; and
a transmission unit configured to transmit the packet generated by the generation unit to the destination device via a network.

4. The network transmission device according to claim 3, wherein
the generation unit generates the packet including the arrival upper-limit information that is determined according to the type of a service provided by the packet.

5. The network transmission device according to claim 3, wherein
the generation unit generates the packet further including arrival lower-limit information that indicates a lower limit of a time range in which the packet should be made to arrive at the destination device.

6. The network transmission device according to claim 5, wherein
the generation unit generates the packet including the arrival lower-limit information that is determined according to the type of a service provided by the packet.

7.-8. (canceled)

9. A non-transitory computer readable storage medium storing a relay program used in a network relay device,
the network relay device constituting a network for relaying a packet,
the relay program being a program for causing a computer to function as:
a reception unit configured to receive the packet that is addressed to a destination device;
an acquisition unit configured to acquire arrival upper-limit information and arrival lower-limit information from the packet received by the reception unit, the arrival upper-limit information indicating an arrival time limit of the packet to the destination device, the arrival lower-limit information indicating a lower limit of a time range in which the packet should be made to arrive at the destination device; and
a transmission unit configured to perform a transmission process of transmitting the packet received by the reception unit, or a packet based on the packet received by the reception unit, wherein
the transmission unit performs a priority control in the transmission process, based on the arrival upper-limit information acquired by the acquisition unit, and puts transmission of the packet on standby based on the arrival lower-limit information acquired by the acquisition unit.

10. A non-transitory computer readable storage medium storing a packet transmission program used in a network transmission device,
the packet transmission program causing a computer to function as:
a generation unit configured to generate a packet to be transmitted to a destination device, the packet including arrival upper-limit information indicating an arrival time limit of the packet to the destination device; and
a transmission unit configured to transmit the packet generated by the generation unit to the destination device via a network.

11. The network transmission device according to claim 4, wherein
the generation unit generates the packet further including arrival lower-limit information that indicates a lower limit of a time range in which the packet should be made to arrive at the destination device.

12. The network relay device according to claim 2, wherein
the transmission unit discards the packet without transmitting the same, when a time length from the current time to the arrival time limit is shorter than a threshold value.

13. The network relay device according to claim 1, wherein
the reception unit receives the packet from a network transmission device, and
the network transmission device and the network relay device are in time-synchronization with each other.

14. The network relay device according to claim 2, wherein
the reception unit receives the packet from a network transmission device, and
the network transmission device and the network relay device are in time-synchronization with each other.

15. The network relay device according to claim 3, wherein
the reception unit receives the packet from a network transmission device, and
the network transmission device and the network relay device are in time-synchronization with each other.

16. The network relay device according to claim 1, wherein
each of the arrival upper-limit information and the arrival lower-limit information is determined according to the type of a service provided by the packet.

17. The network relay device according to claim 2, wherein
each of the arrival upper-limit information and the arrival lower-limit information is determined according to the type of a service provided by the packet.

18. The network relay device according to claim 3, wherein
each of the arrival upper-limit information and the arrival lower-limit information is determined according to the type of a service provided by the packet.

19. The network relay device according to claim 4, wherein
each of the arrival upper-limit information and the arrival lower-limit information is determined according to the type of a service provided by the packet.

20. The network relay device according to claim 1, wherein
the priority control is a process of transmitting a packet, among the packets being held, having the earliest arrival time limit indicated by the arrival upper-limit information.

21. The network relay device according to claim 2, wherein
the priority control is a process of transmitting a packet, among the packets being held, having the earliest arrival time limit indicated by the arrival upper-limit information.

22. The network transmission device according to claim 3, wherein
the network transmission device and a network relay device constituting the network are in time-synchronization with each other.
